(19) United States
(12) Patent Application Publication
(10) Pub. No.: US 2002/0070698 A1
(43) Pub. Date: Jun. 13, 2002

(54) Drive system having at least one electric motor

(76) Inventor: Michael Spingler, Herzogenaurach (DE)

Correspondence Address: BAKER & BOTTS, 30 ROCKEFELLER PLAZA, NEW YORK, NY, 10112

(21) Appl. No.: 09/938,758

(22) Filed: Aug. 24, 2001

(30) Foreign Application Priority Data
Dec. 11, 2000 (DE) 100 61 579.1

(51) Int. Cl. G05B 11/01

(52) U.S. Cl. 318/560

(57) ABSTRACT

A drive system requires controllers for diagnosis and start-up. According to the invention, these controllers are not provided directly at the location of the drive system (M2, ME2, M3, ME3) but are provided physically remotely from the drive system (M2, ME2, M3, ME3) via a commercially available infrared path (I) or radio path (F). For this purpose, the controllers are also in the form of commercially available communication devices, in particular in the form of an organizer (O), a mobile telephone (H) or a Notebook.

### FIELD OF THE INVENTION

The present invention relates to a drive system having at least one electric motor, associated electronic components, and at least one controller which can be connected to it.

### BACKGROUND OF THE INVENTION

In the case of a commercially available drive systems, relatively simple controllers, which are either an integral component of the system or are plugged into the system, are used for the purpose of diagnosis or for simple starting up of the drive system and/or of individual components of the relatively complex drive units. For cost reasons, these controllers are equipped only with relatively small display elements and simple keypads and, as a consequence, offer only limited convenience in their use. Furthermore, when these controllers are in the form of panels they require space for display and control elements on the existing front panels of the device. Such space is extremely limited especially where large-scale-integrated components are used. Also, if the drive systems are installed in machines or industrial systems, the problem frequently arises that the accessibility to the actual drive systems is restricted.

The object of the present invention is to design a drive system such that it allows convenient diagnosis and start-up of drive systems and/or of individual components of complex drive systems in a manner which is as simple as possible.

### SUMMARY OF THE PRESENT INVENTION

In the drive system of the present invention the controller connections are made via a wire-free transmission path, in particular an infrared path or a radio path, so that the diagnosis and start-up can be carried out by an operator at any desired location within the transmission range. Since the infrared path passes via IrDa ports, or the radio path is in the form of a “bluetooth” system, it is possible to make use of commercially available transmission systems. An organizer, a mobile telephone, or PC in the form of a standard device or Notebook can be provided as the controller. In all cases, these are commercially available devices which can be matched to the drive system by software. Moreover, these devices provide the operator with an acceptable operator interface with a high level of display convenience. Since these devices are mass-produced items, they are extremely cost-effective in comparison to their performance.

### DRAWINGS

Exemplary embodiments of the invention are described in more detail below and in the context of the drawing, in which:

FIG. 1 shows a commercially available drive system;

FIG. 2 shows a drive system according to the invention with an infrared path; and

FIG. 3 shows a drive system according to the invention with a radio path.

### DETAILED DESCRIPTION OF THE INVENTION

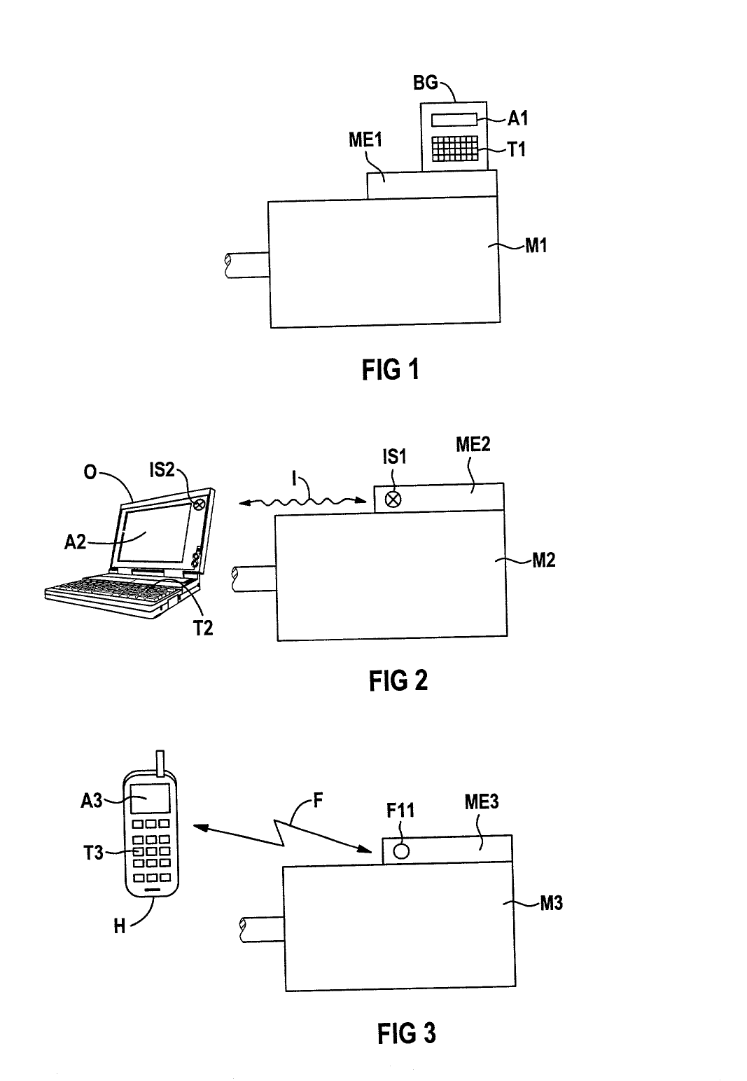

FIG. 1 shows a fundamental representation of how an electric motor M1 is physically associated with a motor electrical system ME1. This association can be effected either such that the motor electrical system ME1 is arranged directly on the motor M1, as shown, although the motor electrical system can, of course, in principle also be accommodated in its own module. The diagnosis and/or starting up of the system comprising the motor M1 and the motor electrical system ME1 are in this case carried out such that a controller BG1 makes electrical contact with the motor electrical system ME1, following which an operator can use a keypad Tl and a display Al to carry out the respective control operations with helpful visualization. In principle, the controller BG could also be an integral component of the motor electronics ME1. However, it is easy to see from this purely fundamental representation the problem that an operator must always carry out his control operations at the location of the motor electronics ME1. It is also easy to see that the controller BG can only be designed in a spatially restricted manner, and hence in a manner which is inconvenient for use, owing to the physical relationships in terms of its display A1 and its keypad T1.

FIG. 2 illustrates the present invention wherein a motor electrical system, in this case a motor electrical system ME2 is likewise provided on the electric motor M2. However, this is not intended for a conventional controller, such as the controller BG1 shown in FIG. 1, since the motor electrical system ME2 has an infrared interface IS1 (indicated by means of a circle with a cross through it) which allows bidirectional data interchange via an infrared path I with an infrared interface IS2 (likewise indicated by a circle with a cross through it) of a commercially available organizer O. The programming of the organizer O in this case ensures the functionality that the control inputs via the keypad T2, which can be visualized via a display A2 on the organizer O, initiate the desired results for the motor electronics ME2. Furthermore, checking procedures on the display A2 also allow system values of the motor electronics ME2 to be transmitted back to the organizer O—including system values relating to the motor M2.

FIG. 3 also shows that a radio device can be used instead of an infrared path, with a radio module FM1 being used in this case on the motor electronics ME2 of a motor M3, which allows bidirectional data traffic, indicated by a zigzag double arrow, with a mobile telephone H. The mobile telephone H in this case has a keypad T3 and a display A3.

I claim:

1. A drive system comprising at least one electric motor, associated electronic components and at least one controller connected thereto, wherein the connection is via a wire-free transmission path.

2. The drive system according to claim 1, wherein the transmission path is an infrared or radio path.

3. The drive system according to claim 2, wherein the infrared path passes via IrDa ports.

4. The drive system according to claim 2, wherein a bluetooth system is provided as the radio path.

5. The drive system according to claim 1, wherein the controller is an organizer.

6. The drive system according to claim 1, wherein the controller is a mobile telephone.

7. The drive system according to claim 1, wherein the controller is a PC in the form of a standard device or Notebook.
